(19) United States
(12) Patent Application Publication
(10) Pub. No.: US 2012/0038614 A1
(43) Pub. Date: Feb. 16, 2012

(54) DISPLAY DEVICE AND DRIVING DEVICE

(76) Inventor: Hidetaka Mizumaki, Osaka (JP)

(21) Appl. No.: 13/202,229

(22) PCT Filed: Jan. 18, 2010
(86) PCT No.: PCT/JP2010/000237

§ 371 Date: Aug. 18, 2011

(30) Foreign Application Priority Data
Feb. 23, 2009 (JP) 2009-039459

(51) Int. Cl. G09G 5/00

(52) U.S. Cl. 345/211

(57) ABSTRACT

Provided is a liquid crystal driving device including an output circuit (28), a bias control section (29) reducing a bias current of the output circuit (28), and a switching circuit (30) connecting source bus lines provided for respective picture elements which have the same color and are provided in adjacent pixels. Further, the liquid crystal driving device employs at least one of: <1> a structure including a resistor reducing a current running through a switch of the switching circuit (30) when the source bus lines are connected to each other by the switch, the resistor and the switch being connected in series; and <2> a structure including a bias current control terminal capable of externally adjusting a bias control signal supplied to the output circuit (28) by the bias control section (29). This provides a display device driving device capable of reducing a noise generated in an AM band.

### TECHNICAL FIELD

The present invention relates to a driving device of a display device such as a liquid crystal display device and a display device provided with the driving device, and more particularly, to a driving device capable of reducing an inrush current generated in a reversal timing of a polarity and a liquid crystal display device provided with the driving device in an active-matrix liquid crystal display device.

### BACKGROUND ART

FIG. 12 shows a block structure of a thin film transistor (TFT) liquid crystal display device. This TFT liquid crystal display device is a representative example of an active-matrix liquid crystal display device as disclosed in Patent Literature 1.

A liquid crystal display device 900 includes a liquid crystal display section and a liquid crystal driving device for driving the liquid crystal display section. The liquid crystal display section is a TFT liquid crystal panel 901 a counter electrode (common electrode) 906. Meanwhile, the liquid crystal driving device includes source drivers 902 each having an integrated circuit (IC), gate drivers 903 each having an IC, a controller 904, and a liquid crystal drive power supply 905 supplying, to the source drivers 902 and the gate drivers 903, a voltage for displaying an image in a liquid crystal panel.

The controller 904 outputs digitized display data D (for example, signals corresponding to red, green, and blue) and various control signals to the source drivers 902, and outputs the various control signals to the gate drivers 903. The main control signals outputted to the source drivers 902 include a horizontal sync signal, a start pulse signal, a clock signal for a source driver, etc. These signals are represented by S1 of FIG. 12. Meanwhile, the main control signals outputted to the gate drivers 903 include a vertical sync signal, a clock signal for a gate driver, etc. These signals are represented by S2 of FIG. 12. Note that a power supply for driving the ICs is not shown in FIG. 12.

Each of the source drivers 902 latches the display data D, which is supplied thereto via the controller 904, in its inside by time division. Then the source driver 902 subjects the display data D to digital-to-analog (DA) conversion in synchronization with a horizontal sync signal (also referred to as a latch signal (LS)) which is supplied thereto by the controller 904. After that, the source driver 902 outputs an analog voltage (gradation display voltage) for gradation display which analog signal is obtained by the DA conversion. At this time, the source driver 902 outputs, via a source bus line (not shown), the analog signal from its respective liquid crystal driving voltage output terminal to a liquid crystal display element (not shown) that corresponds to the liquid crystal driving voltage output terminal and is included in the liquid crystal panel 901.

An output stage of the source drivers 902 includes an output circuit 828, a pulse width adjusting circuit 829, a switching circuit 830, and a 1/n frequency divider circuit 831 as shown in FIG. 13.

As shown in FIG. 13, the switching circuit 830 includes analog switches, i.e., switches 830a and disconnection switches 830b. Each of the switches 830a short-circuits output terminals of the respective same color (R, G, or B) on the basis of a hold signal LSA outputted from the pulse width adjusting circuit 829 prior to output of a voltage which is to be applied to the liquid crystal. Each of the disconnection switches 830b disconnects a corresponding output terminal from the output circuit 828 so that the output terminal is brought into a floating state. Thus, the switching circuit 830 is structured so that a charge sharing operation can be performed for the output terminals of the respective same colors R, G, and B. Note that the charge sharing is a kind of pre-charge. According to the charge sharing, an electric charge stored in a source bus line in a certain horizontal period is used to pre-charge the source bus line in the subsequent horizontal period. The pre-charge is performed in order to apply a voltage to a source bus line in advance before a potential of the source bus line is set to a source signal potential in a certain horizontal period, and an object of the pre-charge is to allow the source bus line to attain the desired source signal potential at an earlier timing by the application of the voltage.

The switching circuit 830 of FIG. 13 is configured such that (i) a source bus line having a positive source signal potential and a source bus line having a negative source signal potential exist in one horizontal period (i.e., basically, dot inversion driving) and (ii) such the source bus lines are short-circuited to each other. This short-circuit of the source bus lines helps a pre-charge operation by use of positive and negative electric charges of data lines of the liquid crystal panel. That is, by utilizing a residual electric charge in the liquid crystal panel, electric power to drive a liquid crystal can be reduced.

### CITATION LIST

### Patent Literature

Patent Literature 1 Japanese Patent Application Publication, Tokukai, No. 2005-208551 A (Publication Date: Aug. 4, 2005)

### SUMMARY OF INVENTION

### Technical Problems

Incidentally, the following fact is known: a noise is generated in an AM band in a reversal timing of dot inversion driving, e.g., in a case of using an on-vehicle module. Because the noise is a frequency component of horizontal synchronization, the noise is problematic as electromagnetic interference.

In the aforementioned structure of Patent Literature 1, the present inventor focused attention on a fact that an inrush current is generated in a reversal timing of the dot inversion driving, i.e., in a timing when an electric charge is transferred from one source bus line to another source bus line, the one source bus line and the another source bus line being provided for picture elements which have the same color and are provided in pixels adjacent to each other. FIG. 14 is a view for comparing waveforms of the latch signal LS, a polarity reversal signal REV, and a source bus line current Is in the structure of Patent Literature 1. FIG. 14 shows that the inrush current occurs in the reversal timing. Specifically, FIG. 14 shows that the inrush current occurs two times, i.e., in a rising timing of a latch period (charge sharing period) and in a timing of a falling edge of the latch period. Analysis of these two inrush currents showed the followings: (i) one of the inrush currents is generated by short-circuiting of the source bus lines due to turning-on of the switch 830a of FIG. 13 (disconnection switch 830b is off) at the time of the rising of the latch period (charge sharing period); and (ii) the other one of the inrush currents is generated by supply of the source signal having an inverted polarity due to turning-on of the disconnection switch 830b (switch 830a) at the time of falling of the latch period (charge sharing period). Further, the present inventor found out that these inrush currents cause the noise.

However, useful means for removing (reducing) the inrush current generated at the time of the rising of the latch period (charge sharing period) or useful means for removing (reducing) the inrush current generated at the time of the falling edge of the latch period (charge sharing period) has not been known so far.

### Solution to Problems

The present invention has been made in view of the aforementioned problems, and an object of the present invention is to provide (i) a driving device that can reduce a noise generated in a reversal timing of the dot inversion driving even if the driving device is used in an on-vehicle module and (ii) a display device provided with the driving device.

In order to attain the aforementioned object, a first driving device of the present invention is a driving device for driving a display section of a display device by applying a voltage to a picture element of the display section, and the first driving device includes: output circuits each for applying, based on a display data signal, a voltage to the picture element in each horizontal period at a source signal potential, which is a potential to be applied to corresponding one of a first source bus line and a second source bus line; and a switching circuit including a first switch and second switches, the first switch connecting the first source bus line and the second source bus line to each other, each of the second switches disconnecting one of the output circuits from corresponding one of the first source bus line and the second source bus line, the first source bus line having a positive source signal potential and the second source bus line having a negative source signal potential in a single horizontal period, the switching circuit including a current suppressing element for reducing a current running through the first switch when the first source bus line and the second source bus line are connected to each other by the first switch, the current suppressing element and the first switch being connected in series.

According to the aforementioned structure, the driving device of the present invention includes the switching circuit including the current suppressing element for reducing a current generated by a difference between electric potentials of the source bus lines connected to each other. This makes it possible to reduce an inrush current generated in a reversal timing of the dot inversion driving, i.e., in a timing when an electric charge is transferred from one source bus line to another source bus line, the one source bus line and the another source bus line being provided for picture elements which have the same color and are provided in pixels adjacent to each other. Therefore, by providing the driving device of the present invention in the display device, it is possible to provide a display device reducing a noise caused by an inrush current.

Specifically, the driving device of the present invention is configured such that (i) source bus lines provided for respective picture elements which have the same color and are provided in pixels adjacent to each other have inverted polarities and (ii) the switching circuit is provided, so that electric charges charged in the respective source bus lines offset each other before their polarities are inverted. Herein, if the switching circuit is capable only of causing the electric charges charged in the respective source bus lines to offset each other before the polarities are inverted, an inrush current according to a difference between the electric potentials of the two lines is generated at the moment when the source bus lines provided for the respective picture elements which have the same color and are provided in the pixels adjacent to each other are electrically connected to each other by the switch, so that the aforementioned problems occur. In contrast to this, the driving device of the present invention includes the switching circuit including a current suppressing element having the aforementioned structure. Therefore, according to the driving device of the present invention, when the source bus lines provided for the respective picture elements which have the same color and are provided in the pixels adjacent to each other are eclectically connected to each other by the switch, it is possible to limit a current flowing between the lines by the current suppressing element, that is, to reduce an inrush current generated. Note that the expression “equal” herein refers not only to a case where potentials of the two lines are completely equal to each other, but also to a case where the potentials of the two lines are substantially equal to each other to such a extent that does not cause problems relating to the inrush current.

Further, in order to attain the aforementioned object, in the present invention, a second driving device of the present invention is a driving device for driving a display section of a display device by applying a voltage to a picture element of the display section, and the driving device includes: output circuits each for applying, on the basis of a display data signal, a voltage to the picture element in each horizontal period at a source signal potential, which is a potential to be applied to corresponding one of a first source bus line and a second source bus line; and a switching circuit including a first switch and second switches, the first switch connecting the first source bus line and the second source bus line to each other, each of the second switches disconnecting one of the output circuits from corresponding one of the first source bus line and the second source bus line, the first source bus line having a positive source signal potential and the second source bus line having a negative source signal potential in a single horizontal period; and bias control means for reducing a bias current of each of the output circuits, the bias control means including a bias current control terminal serving as an external connection terminal capable of adjusting a bias control signal supplied to each of the output circuits by the bias control means.

According to the aforementioned structure, the driving device of the present invention includes a bias current control terminal. This makes it possible to reduce an inrush current generated in a reversal timing of the dot inversion driving, i.e., in a timing when an electric charge is transferred from one source bus line to another source bus line, the one source bus line and the another source bus line being provided for respective picture elements which have the same color and are provided in pixels adjacent to each other. Therefore, it is possible to provide a display device reducing remarkably a noise caused by an inrush current even in the case where the driving device according to the present invention is provided in the display device.

Specifically, the driving device of the present invention is configured such that (i) the source bus lines provided for the respective picture elements which have the same color and are provided in the pixels adjacent to each other have inverted polarities and (ii) the switching circuits is provided so that electric charges charged in the respective source bus lines offset each other before their polarities are inverted. Thus, the switching circuit is capable of causing the electric charges charged in the respective source bus lines to offset each other before the polarities are inverted, however, an inrush current according to a difference between the electric potentials of the two lines is generated at the moment when the source bus lines provided for the respective picture elements which have the same color and are provided in the pixels adjacent to each other are electrically connected to each other by the switch, so that the aforementioned problems occur. In order to deals with this, the driving device of the present invention includes the bias control means for reducing the bias current of the output circuit. This can reduce the inrush current generated. Specifically, by providing the bias control means, a current to be supplied to the output circuit from the output terminal of the bias control means is reduced and the bias current of the output circuit is adjusted to be reduced. This can reduce a slew rate of the output of the output circuit, and can also reduce the inrush current generated even at the moment when the source bus lines provided for the respective picture elements which have the same color and are provided in the pixels adjacent to each other are electrically connected to each other by the switch.

Further, the bias control means includes a bias current control terminal serving as an external connection terminal capable of externally adjusting a bias control signal supplied to each of the output circuits by the bias control means. This makes it possible to adjust the bias current while watching the display section or performing an examination of electromagnetic interference (EMI) after a flexible printed circuit (FPC), the source driver, the gate driver, etc. are mounted in the display device.

Further, the present invention also encompasses a display device driven by the driving device including the aforementioned structure.

Other objects, features, and advantages of the present invention will become apparent sufficiently with reference to the description described below. Further, the advantages of the present invention will be evident in the following description.

### Advantageous Effects of Invention

As described above, a first driving device of the present invention is a driving device for driving a display section of a display device by applying a voltage to a picture element of the display section, and the first driving device includes: output circuits each for applying, based on a display data signal, a voltage to the picture element in each horizontal period at a source signal potential, which is a potential to be applied to corresponding one of a first source bus line and a second source bus line; and a switching circuit including a first switch and second switches, the first switch connecting the first source bus line and the second source bus line to each other, each of the second switches disconnecting one of the output circuits from corresponding one of the first source bus line and the second source bus line, the first source bus line having a positive source signal potential and the second source bus line having a negative source signal potential in a single horizontal period, the switching circuit including a current suppressing element for reducing a current running through the first switch when the first source bus line and the second source bus line are connected to each other by the first switch, the current suppressing element and the first switch being connected in series.

Further, as described above, a second driving device of the present invention is a driving device for driving a display section of a display device by applying a voltage to a picture element of the display section, and the driving device includes: output circuits each for applying, on the basis of a display data signal, a voltage to the picture element in each horizontal period at a source signal potential, which is a potential to be applied to corresponding one of a first source bus line and a second source bus line; and a switching circuit including a first switch and second switches, the first switch connecting the first source bus line and the second source bus line to each other, each of the second switches disconnecting one of the output circuits from corresponding one of the first source bus line and the second source bus line, the first source bus line having a positive source signal potential and the second source bus line having a negative source signal potential in a single horizontal period; and bias control means for reducing a bias current of each of the output circuits, the bias control means including a bias current control terminal serving as an external connection terminal capable of adjusting a bias control signal supplied to each of the output circuits by the bias control means.

This provides effects of (i) reducing the inrush current and (ii) reducing the noise.

### BRIEF DESCRIPTION OF DRAWINGS

FIG. 1 shows a structure of an embodiment of a liquid crystal display device including a driving device according to the present invention.

FIG. 2 shows a structure of a liquid crystal panel provided in the liquid crystal display device of FIG. 1.

FIG. 3 shows a block structure of a source driver provided in the liquid crystal display device of FIG. 1.

FIG. 4 shows a circuit diagram of a switching circuit provided in the source driver of FIG. 3.

FIG. 5 shows a timing of the switching circuit of FIG. 4.

FIG. 6 shows characteristics of the source driver of FIG. 3.

FIG. 7 shows another embodiment of a source driver provided in a liquid crystal display device including a driving device according to the present invention.

FIG. 8 shows characteristics of the source driver of FIG. 7.

FIG. 9 shows still another embodiment of a source driver provided in a liquid crystal display device including a driving device according to the present invention.

FIG. 10 shows characteristics of the source driver of FIG. 9.

FIG. 11 shows yet another embodiment of a source driver provided in a liquid crystal display device including a driving device according to the present invention.

FIG. 12 shows a conventional art.

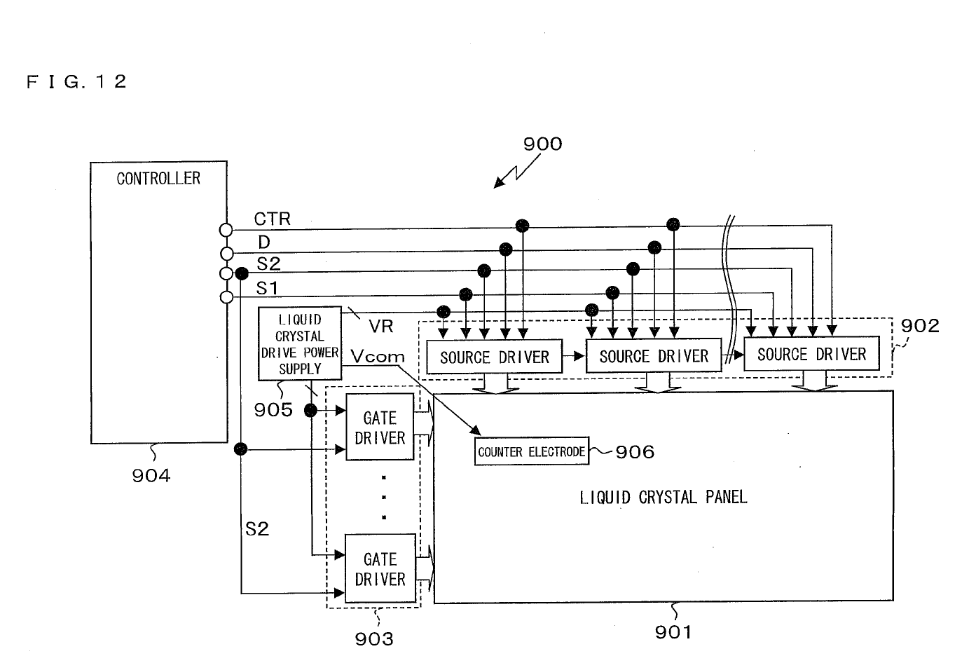

FIG. 13 shows a conventional art.

FIG. 14 shows a conventional art.

### DESCRIPTION OF EMBODIMENTS

### Embodiment 1

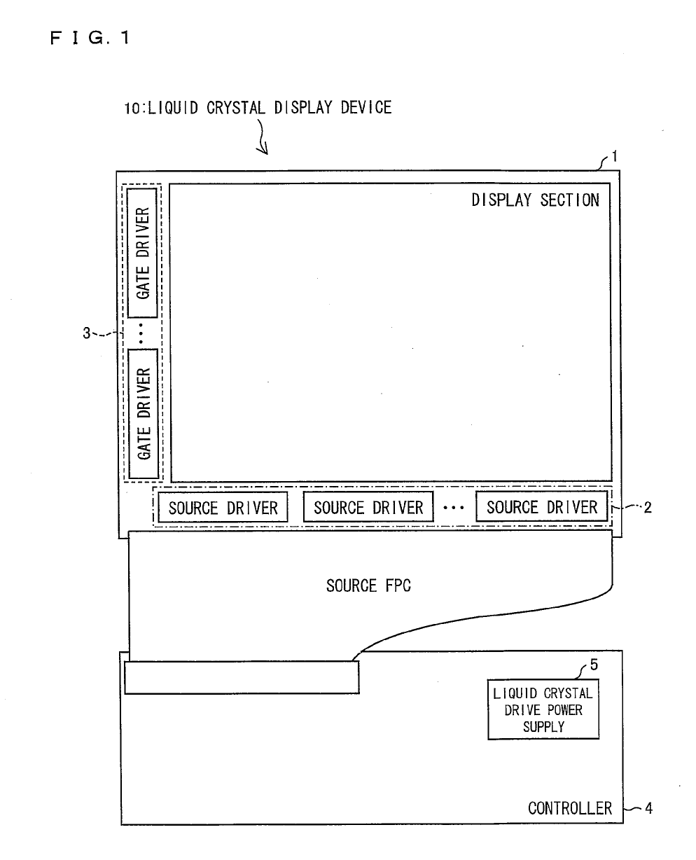

An embodiment of a driving device of the present invention will be described below with reference to FIG. 1 to FIG. 6. This embodiment will be described using a liquid crystal display device as an example of a display device and a liquid crystal driving device as an example of a driving device. First, a structure of the liquid crystal display device including the driving device according to the present invention will be described with reference to FIG. 1.

FIG. 1 shows a block structure of an active matrix liquid crystal display device in this embodiment. The liquid crystal display device includes a TFT liquid crystal panel (display section) 1, a plurality of source drivers 2, a plurality of gate drivers 3, a control circuit 4, and a liquid crystal drive power supply 5. The source drivers 2, the gate drivers 3, the control circuit 4, and the liquid crystal drive power supply 5 constitute the liquid crystal driving device (driving device).

The control circuit 4 transmits a horizontal sync signal to each of the source drivers 2 and each of the gate drivers 3. Display data supplied from the outside (herein, the display data divided into R, G, and B) are inputted as digital signals to the source driver 2 via the control circuit 4. The source driver 2 latches the inputted display data in its inside by time division. After that, the source driver 2 subjects the display data to digital-to-analog conversion in synchronization with the horizontal sync signal supplied from the control circuit 4. Then, the source driver 2 outputs, from its liquid crystal driving output terminal, an analog voltage for gradation display. Note that the control circuit 4 may be structured to transmit a vertical sync signal to the gate driver 3.

<Liquid Crystal Panel>

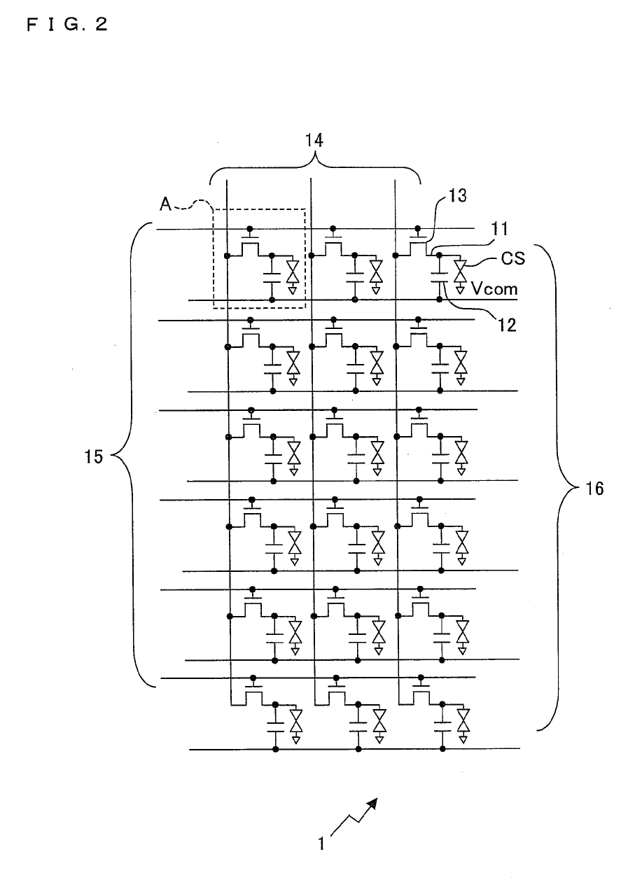

FIG. 2 shows a structure of the liquid crystal panel 1. The liquid crystal panel 1 includes picture element electrodes 11, liquid crystal capacitors 12, storage capacitors Cs, TFTs 13 each serving as an element for turning on and off a voltage applied to a picture element, source bus lines 14, gate bus lines 15, and a counter electrode 16 of the liquid crystal panel (corresponding to a counter electrode of FIG. 1). In FIG. 2, a region represented by A corresponds to a liquid crystal display element for one picture element.

Gradation display voltages are supplied to the source bus lines 14 from the source drivers 2 in accordance with brightness of the picture elements to be displayed. Scanning signals are supplied to the gate bus lines 15 from the gate drivers 3 in order to sequentially turn on the vertically-aligned TFTs 13. When a voltage of each of the source bus lines 14 is applied, through a corresponding TFT 13 which is ON, to a picture element electrode 11 connected to a drain of that TFT 13, an electric charge is accumulated in a liquid crystal capacitor between the picture element electrode 11 and the counter electrode 16. This changes optical transmittance of liquid crystal, thereby performing a display.

<Liquid Crystal Driving Device>

The source drivers 2 and the gate drivers 3 in the liquid crystal driving device are in the form of chip on glass (COG). In addition, the source drivers 2 and the gate drivers 3 are mounted on and connected to an indium tin oxide (ITO; indium tin oxide film) terminals of the liquid crystal panel. However, the present invention is not limited thereto, and the source drivers 2 and the gate drivers 3 may be in the form of tape carrier package (TCP) according to which the IC chips are mounted on a film having a wiring. Alternatively, in the form of the chip on glass (COG), the IC chips may be directly and thermally bonded to the ITO terminals of the liquid crystal panel via an anisotropic conductive film (ACF) for connection.

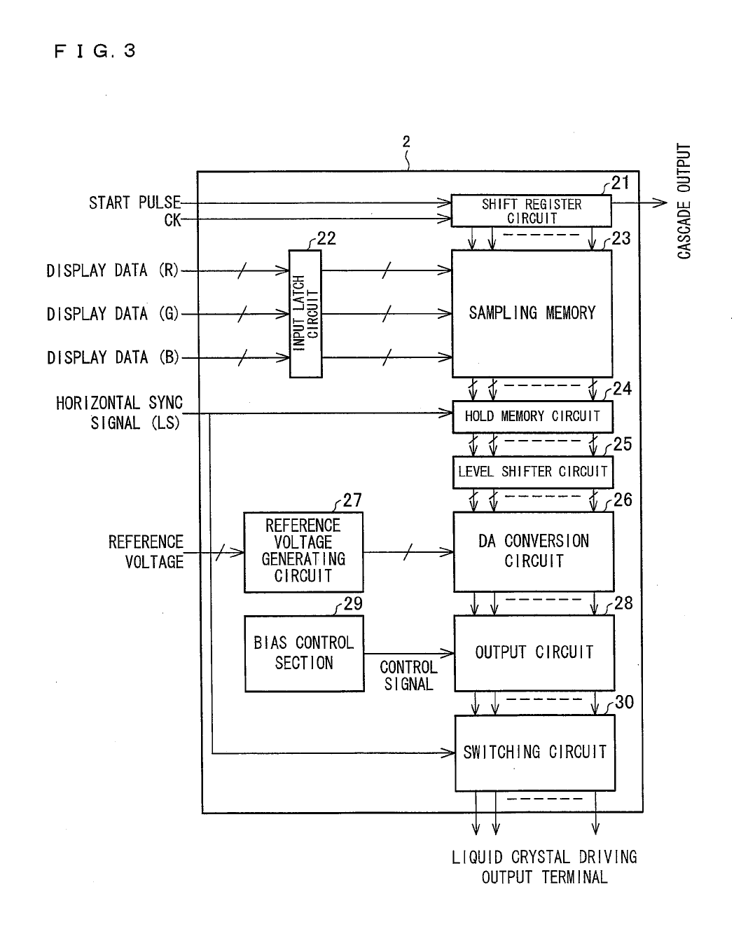

FIG. 3 shows a block structure of each of the source drivers 2. Only the source driver according to this embodiment will be described below. A well-known gate driver is used herein. Therefore description thereof is omitted. As shown in FIG. 3, the source driver includes a shift register 21, an input latching circuit 22, a sampling memory 23, a hold memory 24, a level shifter 25, a DA conversion circuit 26, a reference voltage generating circuit 27, an output circuit 28, a bias control section 29 (bias control means), and a switching circuit 30.

The shift register 21 shifts, in synchronization with a clock signal CK supplied thereto, a start pulse SP supplied thereto. From stages of the shift register 21, control signals are outputted to the sampling memory 23. Note that the start pulse SP is a signal synchronized with a horizontal sync signal LS of a data signal D (of display data DR, DG, or DB). Further, the start pulse SP shifted by the shift register 21 is inputted as a start pulse SP to a shift register 21 in an adjacent source driver, and is shifted therein in a similar manner. Then, the start pulse SP is transferred to a shift register in a source drover which is farthest from the control circuit 4.

The input latching circuit 22 temporarily latches, e.g., the display data DR, DG, and DB each having 6 bits, which are serially inputted to the input terminals corresponding to the respective colors. Then, the input latching circuit 22 transmits the display data DR, DG, and DB to the sampling memory 23.

The sampling memory 23 samples, by use of the output signals supplied from the stages of the shift register 21, the display data DR, DG, and DB (18 bits in total in the case where each of R, G, and B has 6 bits) which are transmitted from the input latching circuit 22 by time division. The sampling memory 23 keeps storing the display data DR, DG, and DB until the display data DR, DG, and DB for one horizontal sync period are all gathered.

The hold memory 24 latches, on the basis of a latch signal LS, the display data DR, DG, and DB supplied thereto. The hold memory 24 keeps holding the display data DR, DG, and DB until the subsequent horizontal sync signal LS is inputted. When the subsequent horizontal sync signal LS is inputted, the level shifter 25 outputs the display data DR, DG, and DB.

The level shifter 25 is a circuit for changing signal levels of the display data DR, DG, and DB by, for example, boosting in order that the display data DR, DG, and DB suit with the subsequent DA conversion circuit 26 for adjusting a level of a voltage applied to the liquid crystal panel 1. The level shifter 25 outputs display data D′R, D′G, and D′B.

The reference voltage generating circuit 27 generates, on the basis of a reference voltage VR supplied from the liquid crystal drive power supply 5 (see FIG. 1), analog voltages of 64 levels which analog voltages are to be used for the gradation display, and outputs the analog voltages to the DA conversion circuit 26.

The DA conversion circuit 26 selects one of the voltages of 64 levels in accordance with the display data D′R, D′G, and D′B (digital) inputted from the level shifter 25, the display data D′R, D′G, and D′B respectively corresponding to R, G, and B, and each having 6 bits. In this way, the DA conversion circuit 26 performs conversion into an analog voltage, and outputs the analog voltage to the output circuit 28. The DA conversion circuit 26 selects switches in accordance with the display data D′R, D′G, and D′B each having 6 bits so as to select one of the voltages of the 64 levels inputted from the reference voltage generating circuit 27.

The output circuit 28 changes the analog signal selected by the DA conversion circuit 26 into a low impedance signal, and outputs the low impedance signal to the switching circuit 30. This output circuit 28 employs a circuit such as a so-called buffer or a so-called voltage follower.

The bias control section 29 corresponds to a control section for determining an output current capability of the output circuit 28, and outputs a bias control signal to the output circuit 28. The bias control section 29 includes NPN transistors Tr1, Tr2, and Tr3. A base of the transistor Tr1 is connected to a power supply Vcc, a collector of the transistor Tr1 is connected to the power supply Vcc, and an emitter of the transistor Tr1 is connected to bases of the transistors Tr2 and Tr3. A collector of the transistor Tr2 is connected to the power supply Vcc, and an emitter of the transistor Tr2 is connected to the ground. A collector of the transistor Tr3 is connected to the power supply Vcc, and an emitter of the transistor Tr3 is connected to the ground. An output terminal 29b of the bias control section 29 is provided between the collector of the transistor Tr3 and the power supply Vcc.

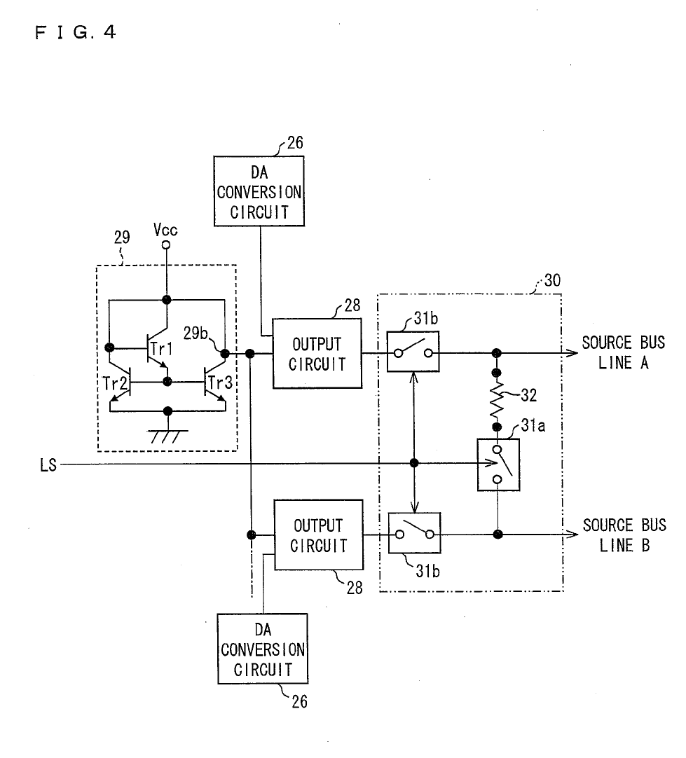

Next, the switching circuit 30 will be described with reference to FIG. 4. FIG. 4 shows a circuit diagram of the switching circuit 30. In addition, for the sake of easy explanation, FIG. 4 also shows a structure of the periphery of the switching circuit 30. Note that only circuits for two output terminals are shown in FIG. 4.

As shown in FIG. 4, the switching circuit 30 includes analog switches, i.e., a connecting switch 31a and disconnecting switches 31b. The connecting switch 31a connects the (two) source bus lines to each other on the basis of the latch signal LS before a voltage applied to the liquid crystal is outputted. Herein, (two) source bus lines are provided for picture elements which have the same color and are provided in pixels adjacent to each other. Each of the disconnecting switches 31b separates a corresponding output terminal from the output circuit 28, to thereby bring the output terminal into a floating state. Thus, the switching circuit 30 is structured to be capable of performing, by use of the connecting switch 31a and the disconnecting switches 31b, a charge sharing operation between the (two) source bus lines provided for the respective picture elements which have the same color and are provided in the pixels adjacent to each other. In addition, the switching circuit 30 also includes a resistor (current suppressing element) 32 connected in series to the connecting switch 31a.

As described above, this embodiment herein is configured such that (i) a source bus line having a positive source signal potential and a source bus line having a negative source signal potential exist in one horizontal period (i.e., basically, a dot inversion driving) and (ii) such the source bus lines are connected to each other. This connection of the source bus lines helps a pre-charge operation by use of positive and negative electric charges of data lines of the liquid crystal panel. That is, by utilizing a residual electric charge in the liquid crystal panel, electric power to drive a liquid crystal can be reduced.

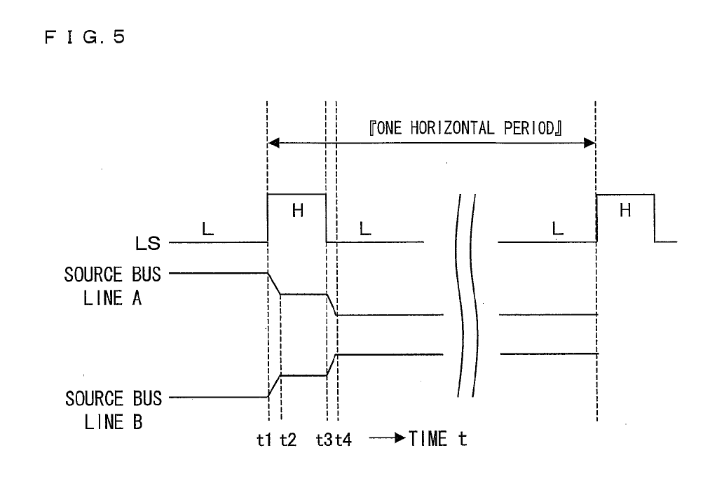

Operations of the connecting switch 31a and the disconnecting switches 31b of the switching circuit 30 will be described in detail below with reference to FIG. 5. FIG. 5 is a timing diagram for illustrating a timing of the switching circuit 30, and a time period between time t1 and time t3 is a high period of the latch signal LS. A source bus line A and a source bus line B of FIG. 5 are arbitrary source bus lines which are opposite in direction of a magnetic field to be applied to the liquid crystal in the dot inversion driving. FIG. 5 shows source signal potentials of the source bus line A and the source bus line B together with the latch signal LS.

The time t1 of FIG. 5 indicates a starting time of one horizontal period. Until the time t1, the latch signal LS keeps a low level, the disconnecting switches 31b are in a closed state (on), and the connecting switch 31a is in an open state (off). First, the starting time t1 of the horizontal period and the rising of the latch signal LS are set to coincide with each other. As a result, at the time t1, the latch signal LS is switched to a high level “H”, the disconnecting switches 31b are turned off, and the connecting switch 31a is turned on. By turning off the disconnecting switches 31b, the output circuit 28 and the output terminals are electrically disconnected from each other. Meanwhile, by turning on the connecting switch 31a, the source bus lines are electrically connected to each other. When the source bus lines are thus electrically connected, an electric charge moves between the source bus lines. However, a current running through the connecting switch 31a is not so increased because the connecting switch 31a and the resistor 32 are connected in series. Therefore, a potential of the source bus line A and a potential of the source bus line B become equal to each other after a predetermined period of time has elapsed (assume that this predetermined period of time is time t2). A time period from the time t1 to the time t2 is an electrical charge/discharge time determined in accordance with a load-carrying capacitance, that is, the time period is determined in accordance with a value of the load-carrying capacitance.

Herein, the electric charge moves between the source bus lines in the time period between the time t1 and the time t2, hence the source driver does not consume electric power.

Next, at the time t3, the latch signal LS is switched to a low level “L”, the disconnecting switches 31b are turned on, and the connecting switch 31a is turned off. Consequently, a circuit condition becomes the same as a circuit condition observed until the time t1. The output circuit 28 discharges and charges the electric charge of the load-carrying capacitance of the source bus line, to thereby consume the electric power. Then, at a certain time (assume that this time is time t4), the signal potentials of the source bus line A and the source bus line B become desired potentials (source signal potentials). A time period from the time t3 to the time t4 is an electric charge/discharge time determined in accordance with the load-carrying capacitance, that is, the time period is determined in accordance with a value of the load-carrying capacitance.

In this way, the following processing is performed:

(a): disconnecting the source bus lines from the source driver at the starting time of one horizontal period;
(b): connecting the source bus lines to each other concurrently with the process (a);
(c): disconnecting the source bus lines from each other after performing the process (b); and
(d): reconnecting the source bus lines and the source driver to each other concurrently with the process (c).

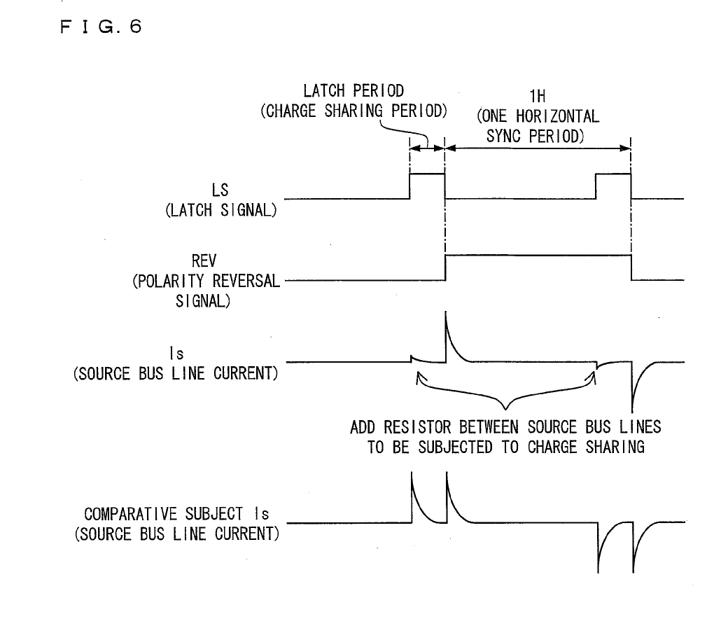

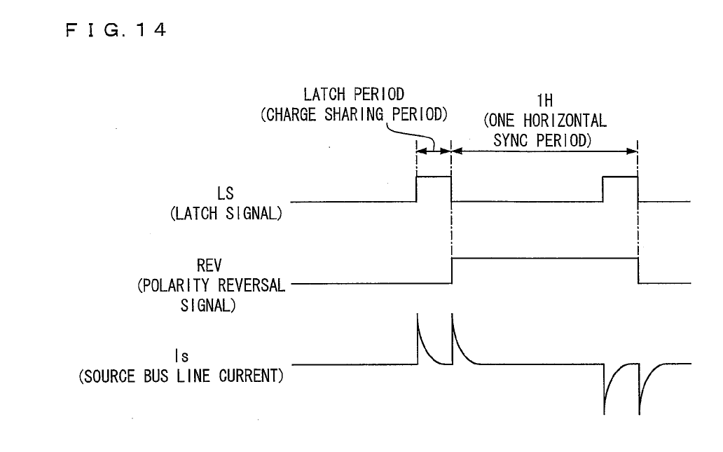

An effect of the resistor 32 will be described with reference to FIG. 6. FIG. 6 is a view for comparing waveforms of the latch signal LS, a polarity reversal signal REV, and a source bus line current Is. Note that, FIG. 6 shows also the source bus line current Is of the conventional source driver of FIG. 14 in order to compare the source bus line current Is of the present invention with the source bus line current Is of the conventional source driver.

As shown in FIG. 6, in the source bus line current Is of this embodiment, generation of an inrush current is prevented in the rising timing of a latch period (charge sharing period) in which the inrush current is generated in the conventional structure. The reason for this is as follows: thanks to the resistor 32, a current generated at the moment when the source bus lines provided for the respective picture elements which have the same color and are provided in the pixels adjacent to each other are electrically connected to each other by the switch can be reduced to a value obtained by (difference between electric potentials of lines)/(resistance of resistor).

As described above, the structure of this embodiment can effectively reduce the inrush current generated in the rising timing of the latch period (charge sharing period) in the conventional structure. In this way, the liquid crystal display device 10 (FIG. 1) of this embodiment is capable of reducing a noise generated in an AM band in a reversal timing in the dot inversion driving.

Note that the structure in which the resistor 32 is provided in the switching circuit 30 is described in this embodiment, but the present invention is not limited thereto. For example, a field effect transistor (known as, e.g., a MOS resistor) having a gate to which adjusted voltage is applied may be used. This makes it possible to reduce a resistance (herein, a channel resistance) between a source and a drain of the field effect transistor, thereby obtaining an effect same as the aforementioned effect obtained by using the resistor 32.

### Embodiment 2

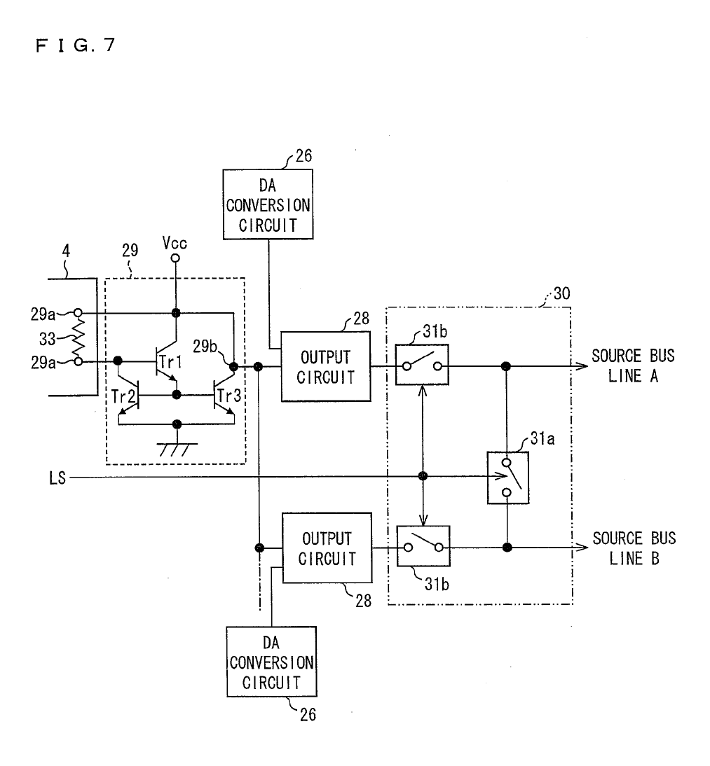

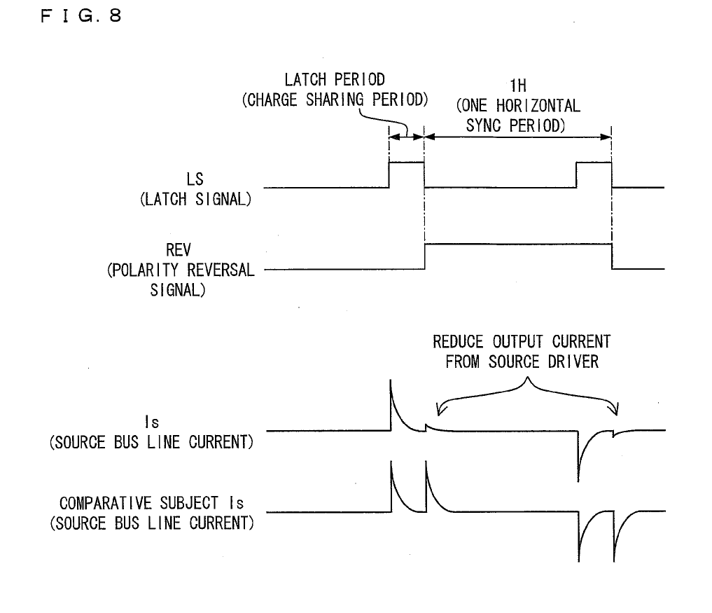

Another embodiment according to the present invention will be described below with reference to FIG. 7 and FIG. 8. Note that the description herein deals with differences between this embodiment and Embodiment 1. Therefore, for the sake of easy explanation, the same members as those of Embodiment 1 are denoted by the same reference symbols, and the detailed description thereof is omitted.

FIG. 7 shows a circuit diagram of a bias control section 29. In addition, for the sake of easy explanation, FIG. 7 shows also a structure of the periphery of the bias control section 29.

Embodiment 1 includes, as shown in FIG. 4, the resistor 32 connecting in series to the connecting switch 31a of the switching circuit 30. In contrast to this, as shown in FIG. 7, a source driver 2 of a liquid crystal driving device of this embodiment includes, instead of the resistor 32 in the switching circuit 30 of Embodiment 1, a bias control resistor 33 connected to a bias control terminal 29a of a bias control section 29. Furthermore, the bias control resistor 33 is exposed to the outside of the bias control section 29, specifically, is located on the control circuit 4.

The bias control section 29 includes NPN transistors Tr1, Tr2, and Tr3. A base of the transistor Tr1 is connected to a power supply Vcc via the bias control resistor 33, a collector of the transistor Tr1 is connected to the power supply Vcc, and an emitter of the transistor Tr1 is connected to bases of the transistors Tr2 and Tr3. A collector of the transistor Tr2 is connected to the power supply Vcc via the bias control resistor 33, and an emitter of the transistor Tr2 is connected to the ground. A collector of the transistor Tr3 is connected to the power supply Vcc, and an emitter of the transistor Tr3 is connected to the ground. An output terminal 29b of the bias control section 29 is provided between the collector of the transistor Tr3 and the power supply Vcc.

Addition of the resistor (bias control resistor 33) to the bias control terminal 29a of the bias control section 29 makes it possible to control a bias current of an output circuit 28, specifically, a current running through an output side of a transistor provided in the output circuit 28 so that the transistor functions as a current source of a differential pair in order to determine a slew rate of the output.

FIG. 8 shows an effect of the bias control resistor 33. FIG. 8 is a view for comparing waveforms of a latch signal LS, a polarity reversal signal REV, and a source bus line current Is. Note that, similarly to FIG. 6 of Embodiment 1, FIG. 8 shows also the source bus line current Is of the conventional source driver of FIG. 14 in order to compare the source bus line current Is of the present invention with the source bus line current Is of the conventional source driver.

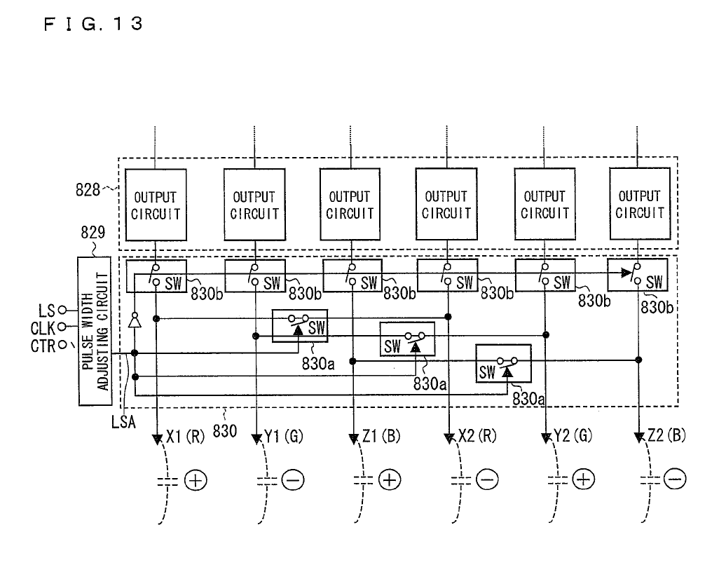

In the conventional structure, an inrush current is generated by supply of a source signal having an inverted polarity due to turning-on of a disconnection switch 830b (FIG. 13) in the falling timing of the latch period (charge sharing period). In contrast to this, in the source bus line current Is of this embodiment, generation of the inrush current is reduced as shown in FIG. 8. The reason for this is as follows: providing the bias control resistor 33 of FIG. 7 reduces a current supplied to the output circuit 28 from the output terminal 29b of the bias control section 29, and accordingly the bias current of the output circuit 28 is adjusted to become smaller, thereby making it possible to reduce a slew rate of the output of the output circuit 28.

Particularly, providing the bias control resistor 33 on the control circuit 4 makes it possible to change a resistance of the resistor (bias control resistor 33) even after the driver is mounted, thereby adjusting a value of the bias current of the output circuit 28.

The structure of this embodiment can effectively reduce the inrush current generated in the falling timing of the latch period (charge sharing period) in the conventional structure. In this way, the liquid crystal display device of this embodiment is capable of reducing a noise generated in the AM band in a reversal timing in the dot inversion driving.

### Embodiment 3

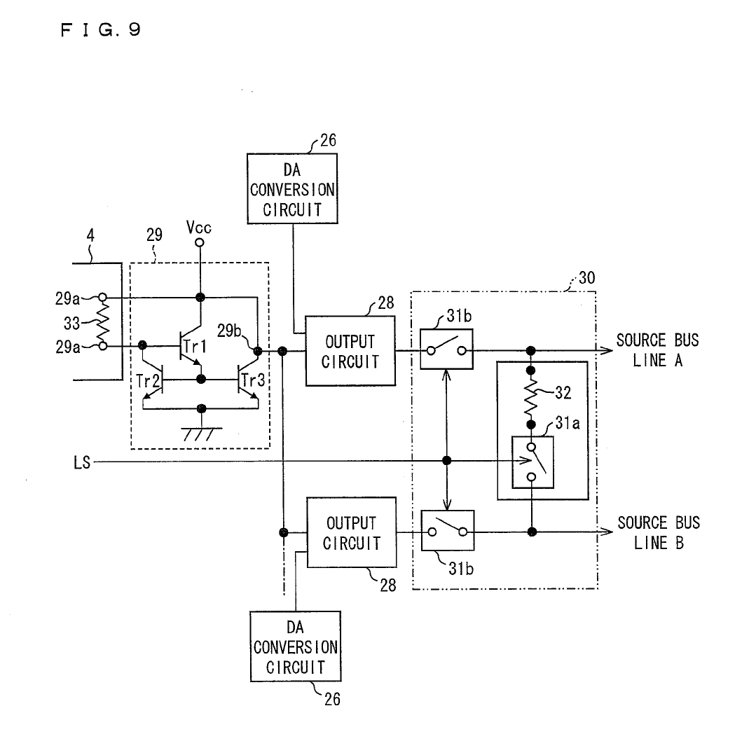

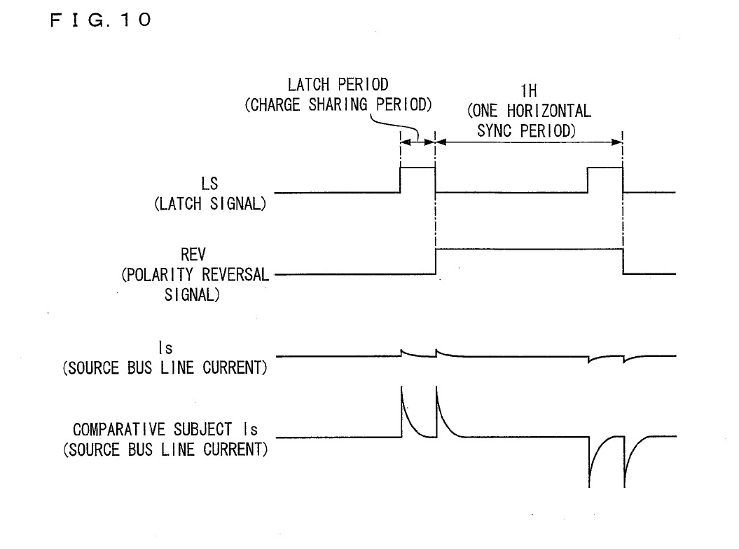

Another embodiment according to the present invention will be described below with reference to FIG. 9 and FIG. 10. Note that the description herein deals with differences between this embodiment and Embodiment 1. Therefore, for the sake of easy explanation, the same members as those of Embodiment 1 are denoted by the same reference symbols, and the detailed description thereof is omitted.

FIG. 9 shows a circuit diagram of a bias control section 29 and a switching circuit 30. In addition, for the sake of easy explanation, FIG. 9 shows also a structure of the periphery of the bias control section 29 and the switching circuit 30.

Embodiment 1 includes, as shown in FIG. 4, the resistor 32 connecting in series to the connecting switch 31a of the switching circuit 30. In contrast to this, as shown in FIG. 9, a source driver 2 of a liquid crystal driving device of this embodiment includes, in addition to a resistor 32 included in the switching circuit 30, a bias control resistor 33 connected to a bias control terminal 29a of the bias control section 29. Further, the bias control resistor 33 is exposed to the outside of the bias control section 29, specifically, is located on the control circuit 4.

Connecting the resistor (bias control resistor 33) to the bias control terminal 29a of the bias control section 29 makes it possible to control a bias current of an output circuit 28, specifically, a current running through an output side of a transistor in the output circuit 28. A specific structure of the bias control section 29 is the same as in Embodiment 2, and therefore description thereof is herein omitted.

FIG. 10 shows an effect obtained by providing the resistor 32 of the switching circuit 30 and the bias control resistor 33 of the bias control section 29. FIG. 10 is a view for comparing waveforms of a latch signal LS, a polarity reversal signal REV, and a source bus line current Is. Note that, similarly to FIG. 6 of Embodiment 1, FIG. 10 shows also the source bus line current Is of the conventional source driver of FIG. 14 in order to compare the source bus line current Is of the present invention with the source bus line current Is of the conventional source driver.

As shown in FIG. 10, in the source bus line current Is of this embodiment, an inrush current is reduced in rising and falling timings of a latch period (charge sharing period) in which the inrush current is generated in the conventional structure. The inrush current generated in the rising timing of the latch period can be reduced for the following reason: thanks to the resistor 32, a current generated at the moment when source bus lines provided for respective picture elements which have the same color and are provided in pixels adjacent to each other are electrically connected to each other by the switch can be reduced to a value obtained by (difference between electric potentials of lines)/(resistance of resistor). Further, the inrush current generated in the falling timing of the latch period can be reduced for the following reason: providing the bias control resistor 33 reduces a current supplied to the output circuit 28 from an output terminal 29b of the bias control section 29, and accordingly the bias current of the output circuit 28 is adjusted to become smaller, thereby making it possible to reduce a slew rate of an output of the output circuit 28.

Further, particularly, providing the bias control resistor 33 on the control circuit 4 makes it possible to change a resistance of the resistor (bias control resistor 33) even after the driver is mounted, thereby adjusting a value of the bias current of the output circuit 28. In terms of this, this embodiment is advantageous.

The structure according to this embodiment includes the resistor 32 and the bias control resistor 33, and therefore can reduce (i) the inrush current in the rising timing of the latch period (charge sharing period) and (ii) the inrush current in the falling timing of the latch period which are generated in the conventional structure. Thus, as compared with Embodiment 1 and Embodiment 2, this embodiment can effectively reduce the inrush current generated, hence the liquid crystal display device of this embodiment can further reduce the noise generated in the AM band in a reversal timing in the dot inversion driving.

### Embodiment 4

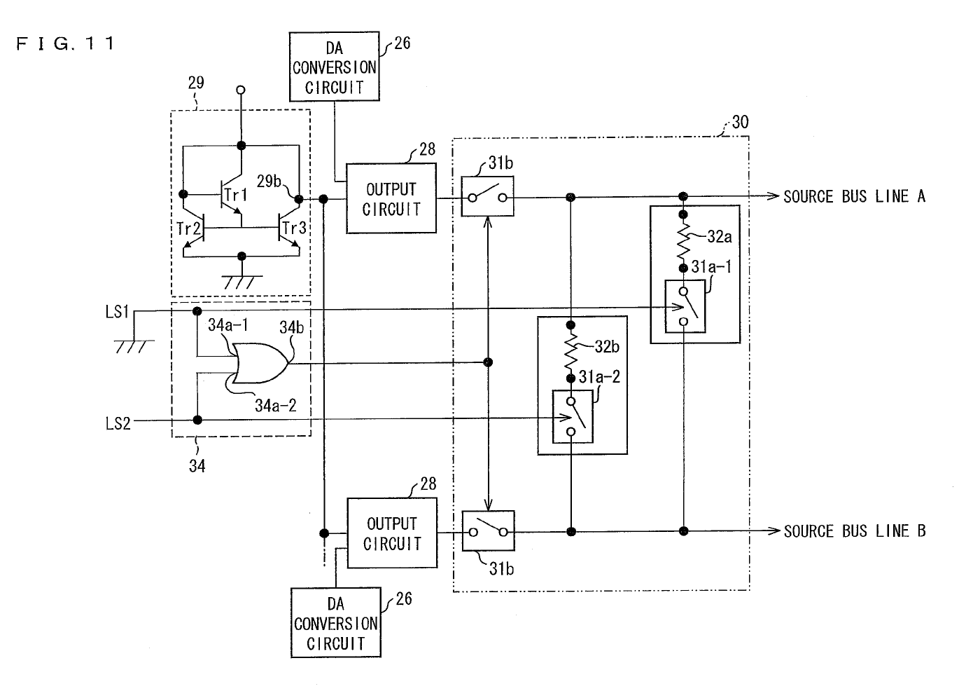

Another embodiment according to the present invention will be described below with reference to FIG. 11. Note that the description herein deals with differences between this embodiment and Embodiment 1. Therefore, for the sake of easy explanation, the same members as those of Embodiment 1 are denoted by the same reference symbols, and the detailed description thereof is omitted.

FIG. 11 shows a circuit diagram of a switching circuit 30. In addition, for the sake of easy explanation, FIG. 11 shows also a structure of the periphery of the switching circuit 30.

As shown in FIG. 4, Embodiment 1 is configured such that one set of the connecting switch 31a and the resistor 32 is provided between the source bus lines provided for the respective picture elements which have the same color and are provided in the pixels adjacent to each other. In contrast to this, a source driver 2 of a liquid crystal driving device of this embodiment is configured such that (i) two sets of connecting switches 31a and resistors 32 (suppression members) are provided between source bus lines provided for respective picture elements which have the same color and are provided in pixels adjacent to each other and (ii) a resistance of a resistor 32a of one of the two sets is different from a resistance of a resistor 32b of the other one of the two sets. Further, in this embodiment, a selecting element 34 having an OR (logical sum) gate is provided in the source driver so as to select at least one of these two sets. Note that “LS1” and “LS2” of FIG. 11 do not indicate different signals, but are shown in order that input terminals supplied with LS signals are distinguished from each other.

Specifically, the switching circuit 30 of this embodiment includes, between the source bus lines provided for the respective picture elements which have the same color and are provided in the pixels adjacent to each other, two connecting switches 31a-1 and 31a-2 which are connected in parallel to each other. One of the two connecting switches, i.e., the connecting switch 31a-1 is provided with the resistor 32a having, for example, a resistance of 20 kΩ in such a manner that the connecting switch 31a-1 and the resistor 32a are connected in series. Further, the other one of the two connecting switches, i.e., the connecting switch 31a-2 is provided with the resistor 32b having, for example, a resistance of 10 kΩ in such a manner that the connecting switch 31a-2 and the resistor 32b are connected in series.

The selecting element 34 includes input terminals 34a-1 and 34a-2 and an output terminal 34b. The input terminal 34a-1 is provided for inputting LS1 serving as a control signal of the connecting switch 31a-1. The input terminal 34a-2 is provided for inputting LS2 serving as a control signal of the connecting switch 31a-2. The output terminal 34b is provided for outputting a signal for controlling a disconnecting switch 31b. The selecting element 34 controls the disconnecting switch 31b by use of at least one of the LS1 and the LS2 supplied from the input terminals 34a-1 and 34a-2. Specifically, the selecting element 34 outputs “High” when at least one of a plurality of inputs is “High”, and outputs “Low” when none of the plurality of inputs is “High”. In a case where the LS1 is “Low” (GND) and the LS2 is “High” of FIG. 11, an output is “High”, and the output “High” is inputted into the disconnecting switch 31b (i.e., the output “High” is a signal to turn off the disconnecting switch 31b). The LS1 is “Low”, the connecting switch 31a-1 connected in series to the resistor 32a enters into an open state (off). Meanwhile, the LS2 is “High”, so that the connecting switch 31a-2 connected in series to the resistor 32b enters into a closed state (on). In order to use the connecting switch 31a-2 connected in series to the resistor 32b, the LS1 is set to “High” and the LS2 is set to “Low (GND)”. In order to turn on the disconnecting switch 31b, each of LS1 and LS2 is set to “Low”. Further, both the connecting switches 31a-1 and 31a-2 can be used by setting each of LS1 and LS2 to “High”. The use of both the connecting switches 31a-1 and 31a-2 allows the driving device to be driven with a lower resistance as compared with a case of using one of the resistors of the connecting switches 31a-1 and 31a-2.

Note that, in this embodiment, two kinds of the resistors are provided between the source bus lines A and B, but the present invention is not limited thereto. For example, three or more kinds of resistors can be also provided in the same way as the aforementioned embodiment. By structuring as described above, the driving device of this embodiment can be used for various kinds of source bus resistors.

As described above, in order to attain the aforementioned object, a first driving device of the present invention is a driving device for driving a display section of a display device by applying a voltage to a picture element of the display section, and the first driving device includes: output circuits each for applying, based on a display data signal, a voltage to the picture element in each horizontal period at a source signal potential, which is a potential to be applied to corresponding one of a first source bus line and a second source bus line; and a switching circuit including a first switch and second switches, the first switch connecting the first source bus line and the second source bus line to each other, each of the second switches disconnecting one of the output circuits from corresponding one of the first source bus line and the second source bus line, the first source bus line having a positive source signal potential and the second source bus line having a negative source signal potential in a single horizontal period, the switching circuit including a current suppressing element for reducing a current running through the first switch when the first source bus line and the second source bus line are connected to each other by the first switch, the current suppressing element and the first switch being connected in series. This structure may employ the current suppressing element as a resistor.

With the aforementioned structure, thanks to the register, a current generated at the moment when the source bus lines provided for respective picture elements which have the same color and are provided in pixels adjacent to each other are electrically connected to each other by the switch can be reduced to a value obtained by (difference between electric potentials of lines)/(resistance of resistor). This makes it possible to reduce an inrush current generated in a rising timing of a latch period (charge sharing period).

Further, as another structure, the first driving device of the present invention may be configured such that the current suppressing element is a field effect transistor and the current running through the first switch is reduced by a channel resistance of the field effect transistors may reduce the current running through the first switch.

According to the aforementioned structure, it is possible to change a channel resistance by adjusting a voltage applied to a gate of the field effect transistor, so as to reduce a current generated at the moment when the source bus lines provided for the respective picture elements which have the same color and are provided in the pixels adjacent to each other are electrically connected to each other by the switch.

Further, in addition to the aforementioned structure, the first driving device according to the present invention preferably further includes: bias control means for controlling a bias current of each of the output circuits. The bias control means preferably includes a bias current control terminal serving as an external connection terminal capable of externally adjusting a bias control signal supplied to each of the output circuits from the bias control means.

According to the above structure, the driving device of the present invention includes the current suppressing element and the bias current control terminal. This makes it possible to more effectively reduce the inrush current generated in the source bus line.

Specifically, because the bias current control terminal capable of externally adjusting the bias control signal supplied to the output circuit is provided, it is possible to connect the terminal to a resistor or a power supply so as to reduce a current supplied to the output circuit from the bias control means and to reduce the bias current of the output circuit, thereby reducing a slew rate of an output of the output circuit. This makes it possible to reduce an inrush current generated in a falling timing of the latch period.

Thus, because the first driving device of the present invention includes the bias current control terminal in addition to the current suppressing element, the first driving device of the present invention can reduce an inrush current generated in a rising timing of a latch period (charge sharing period) in which the inrush current is generated in the conventional structure, and also can reduce an inrush current in a timing to start outputting a source signal from the source driver.

Further, because the bias current control terminal is provided in the outside of the driving device, it is possible to adjust the bias current while watching the display section or performing an examination of electromagnetic interference (EMI) after a flexible printed board (flexible printed circuit (FPC)), the source driver, the gate driver, etc. are mounted.

Specifically, in addition to the aforementioned structures, the first driving device according to the present invention preferably further includes a control substrate, the control substrate including the bias current control terminal.

According to the aforementioned structure, because the bias current control terminal is provided on the control substrate, the bias current can be controlled easily even after the driver is mounted.

Further, in addition to the aforementioned structures, the first driving device according to the present invention is preferably structured such that: the first switch includes a plurality of first switches; the current suppressing element includes a plurality of current suppressing elements; each one of the plurality of first switches and corresponding one of the plurality of current suppressing elements are connected in series so as to constitute a series circuit, and the series circuits are provided in parallel to one another between the first source bus line and the second source bus line; the plurality of current suppressing elements reduce respective different amounts of currents running through the respective first switches; and; and the plurality of first switches are preferably controlled independently from each other.

With this, it is possible to provide a plurality kinds of resistors between the source bus lines provided for the respective picture elements which have the same color and are provided in the pixels adjacent to each other, thereby making it possible to reduce, with use of a desired resistor that is selected from the plurality kinds of resistors, a current generated at the moment when the source bus lines provided for the respective picture elements which have the same color and are provided in the pixels adjacent to each other are electrically connected by the first switches.

Further, in order to attain the aforementioned object, in the present invention, a second driving device of the present invention is a driving device for driving a display section of a display device by applying a voltage to a picture element of the display section, and the driving device includes: output circuits each for applying, on the basis of a display data signal, a voltage to the picture element in each horizontal period at a source signal potential, which is a potential to be applied to corresponding one of a first source bus line and a second source bus line; and a switching circuit including a first switch and second switches, the first switch connecting the first source bus line and the second source bus line to each other, each of the second switches disconnecting one of the output circuits from corresponding one of the first source bus line and the second source bus line, the first source bus line having a positive source signal potential and the second source bus line having a negative source signal potential in a single horizontal period; and bias control means for reducing a bias current of each of the output circuits, the bias control means including a bias current control terminal serving as an external connection terminal capable of adjusting a bias control signal supplied to each of the output circuits by the bias control means. As described above, the bias current control terminal can be connected to the resistor.

With this, it is possible to reduce a current supplied to the output circuit from the bias control means, thereby reducing a bias current of the output circuit.

Further, in place of the resistor, the bias current control terminal may be connected to a direct current inputted directly to the bias control means.

With this structure, an output of the bias control section can be adjusted only by changing setting of an output current or an output voltage of the connected power supply.

Further, in addition to the aforementioned structure, the second driving device of the present invention preferably further includes a control substrate, the control substrate including the bias current control terminal.

This makes it possible to easily control a bias current even after the driver is mounted.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the claims set forth below.

### INDUSTRIAL APPLICABILITY

A driving device according to the present invention can be widely used as a driving device of a display device such as a liquid crystal display device, and for example, can be preferably used in an on-vehicle module.

### REFERENCE SIGNS LIST

1 liquid crystal panel (display section)
2 source driver
3 gate driver
4 control circuit
5 liquid crystal drive power supply
10 liquid crystal display device (driving device)
11 picture element electrode
12 liquid crystal capacitor
13 TFT
14 source bus line
15 gate bus line
16 counter electrode
21 shift register
22 input latch circuit
23 sampling memory
24 hold memory
25 level shifter
26 DA conversion circuit
27 reference voltage generating circuit
28 output circuit
29 bias control section (bias control means)
29a bias control terminal
29b output terminal
30 switching circuit
31a connecting switch
31a-1 connecting switch
31a-2 connecting switch
31b disconnecting switch
32 resistor (current suppressing element)
32a resistor (current suppressing element)
32b resistor (current suppressing element)
33 bias control resistor
34 selecting element
34a-1 input terminal
34a-2 input terminal
34b output terminal

1. A driving device for driving a display section of a display device by applying a voltage to a picture element of the display section, the driving device comprising:
output circuits each for applying, on the basis of a display data signal, a voltage to the picture element in each horizontal period at a source signal potential, which is a potential to be applied to corresponding one of a first source bus line and a second source bus line; and
a switching circuit including a first switch and second switches, the first switch connecting the first source bus line and the second source bus line to each other, each of the second switches disconnecting one of the output circuits from corresponding one of the first source bus line and the second source bus line, the first source bus line having a positive source signal potential and the second source bus line having a negative source signal potential in a single horizontal period,
the switching circuit including a current suppressing element for reducing a current running through the first switch when the first source bus line and the second source bus line are connected to each other by the first switch, the current suppressing element and the first switch being connected in series.

2. The driving device according to claim 1, wherein the current suppressing element is a resistor.

3. The driving device according to claim 1, wherein:
the current suppressing element is a field effect transistor; and
the current running through the first switch is reduced by a channel resistance of the field effect transistor.

4. The driving device according to claim 1, further comprising:
bias control means for controlling a bias current of each of the output circuits,
the bias control means including a bias current control terminal serving as an external connection terminal capable of externally adjusting a bias control signal supplied to each of the output circuits by the bias control means.

5. The driving device according to claim 4, further comprising a control substrate,
the control substrate including the bias current control terminal.

6. The driving device according to claim 1, wherein:
the first switch includes a plurality of first switches;
the current suppressing element includes a plurality of current suppressing elements;
each one of the plurality of first switches and corresponding one of the plurality of current suppressing elements are connected in series so as to constitute a series circuit, and the series circuits are provided in parallel to one another between the first source bus line and the second source bus line;
the plurality of current suppressing elements reduce respective different amounts of currents running through the respective first switches; and
the plurality of first switches are capable of setting, independently from each other, timings for performing on/off control.

7. A driving device for driving a display section of a display device by applying a voltage to a picture element of the display section, the driving device comprising:
output circuits each for applying, on the basis of a display data signal, a voltage to the picture element in each horizontal period at a source signal potential which is a potential to be applied to corresponding one of a first source bus line and a second source bus line;
a switching circuit including a first switch and second switches, the first switch connecting the first source bus line and the second source bus line to each other, each of the second switches disconnecting one of the output circuits from corresponding one of the first source bus line and the second source bus line, the first source bus line having a positive source signal potential and the second source bus line having a negative source signal potential in a single horizontal period; and
bias control means for reducing a bias current of each of the output circuits,
the bias control means including a bias current control terminal serving as an external connection terminal capable of externally adjusting a bias control signal supplied to each of the output circuits by the bias control means.

8. The driving device according to claim 7, wherein the bias current control terminal is connected to a resistor.

9. The driving device according to claim 7, wherein the bias current control terminal is connected to an output of a power supply.

10. The driving device according to claim 7, further comprising a control substrate,
the control substrate including the bias current control terminal.

11. A display device driven by a driving device recited in claim 1.
